(19) United States
(12) Patent Application Publication
(10) Pub. No.: US 2024/0012348 A1
(43) Pub. Date: Jan. 11, 2024

(54) FLEXIBLE PACKAGING MATERIAL

(71) Applicant: HEWLETT-PACKARD DEVELOPMENT COMPANY, L.P., Spring, TX (US)

(72) Inventors: Boris Kaziev, Nes Ziona (IL); Daniel Skvirsky, Nes Ziona (IL); Albert Teishev, Nes Ziona (IL)

(21) Appl. No.: 17/913,408

(22) PCT Filed: Apr. 7, 2020
(86) PCT No.: PCT/US2020/027013

§ 371 Date: Sep. 21, 2022

(51) Int. Cl. G03G 15/16; G03G 9/12

(52) U.S. Cl. CPC G03G 15/162; G03G 9/12

(57) ABSTRACT

Described herein is a process for preparing a flexible packaging material comprising contacting a first flexible material of a layered substrate with an intermediate transfer member; wherein the layered substrate comprises the first flexible material and a thermally activatable laminating material disposed on the first flexible material; transferring an electrophotographic ink composition from a photoimaging plate onto the thermally activatable laminating material of the layered substrate on the intermediate transfer member to form an image layer on the thermally activatable laminating material; and contacting, under conditions of heat and/or pressure, the image layer with a second flexible material thereby forming the flexible packaging material. Also described herein is an electrophotographic printer for use in the process for preparing a flexible packaging material.

### BACKGROUND

All manner of consumer goods, in particular food products, are packaged using thin films or sheets of flexible packaging material, with images such as corporate branding, or product information printed onto the film. The flexible packaging material serves to protect the product from, for example, moisture, oxidation or pathogens, while also providing information to the user regarding the nature and origin of the product contained therein.

### BRIEF DESCRIPTION OF THE FIGURES

FIG. 1 is a schematic process for producing a flexible packaging material.

FIG. 2 is a schematic illustration of an intermediate transfer member (ITM).

### DETAILED DESCRIPTION

Before the present disclosure is disclosed and described, it is to be understood that this disclosure is not restricted to the particular process features and materials disclosed herein because such process features and materials may vary somewhat.

It is noted that, as used in this specification and the appended claims, the singular forms “a”, “an”, and “the” include plural referents unless the context clearly dictates otherwise.

As used herein, “carrier fluid”, “carrier liquid”, “carrier”, or “carrier vehicle” refers to the fluid in which pigment particles, colorant, charge directors and other additives can be dispersed to form a liquid electrostatic composition or electrophotographic composition. The carrier liquids may include a mixture of a variety of different agents, such as surfactants, co-solvents, viscosity modifiers, and/or other possible ingredients.

As used herein, “electrostatic ink composition” or “electrophotographic ink composition” generally refers to an ink composition that is generally suitable for use in an electrostatic printing process, sometimes termed an electrophotographic printing process. It may comprise pigment particles, which may comprise a thermoplastic resin.

As used herein, “pigment” generally includes pigment colorants, magnetic particles, aluminas, silicas, and/or other ceramics or organometallics, whether or not such particulates impart colour. Thus, though the present description primarily exemplifies the use of pigment colorants, the term “pigment” can be used more generally to describe not just pigment colorants, but other pigments such as organometallics, ferrites, ceramics, etc.

As used herein, “co-polymer” refers to a polymer that is polymerized from at least two monomers.

As used herein, “lamination bond strength” refers to the force (per length) required to delaminate a laminated material, and is expressed in units of Newton/inch, or N/in. The lamination bond strength can be measured according to standard techniques, in particular ASTM F0904-98R08. Unless otherwise stated, the lamination bond strength of a flexible packaging material described herein refers to the strength to delaminate the individual layers of the flexible packaging from each other.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used herein, “acidity”, “acid number”, or “acid value” refers to the mass of potassium hydroxide (KOH) in milligrams that neutralizes one gram of a substance. The acidity of a polymer can be measured according to standard techniques, for example, as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity@140° C., units are mPa·s or cPoise. In some examples, the melt viscosity can be measured using a rheometer, e.g. a commercially available AR-2000 Rheometer from Thermal Analysis Instruments, using the geometry of: 25 mm steel plate—standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid composition is employed in the electrophotographic process rather than a powder toner. An electrostatic printing process may involve subjecting the electrostatic composition to an electric field, e.g. an electric field having a field gradient of 50-400 V/μm, or more, in some examples, 600-900 V/μm, or more.

As used herein, “substituted” may indicate that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, etc.

As used herein, “heteroatom” may refer to nitrogen, oxygen, halogens, phosphorus, or sulfur.

As used herein, “alkyl” may refer to a branched, unbranched, or cyclic saturated hydrocarbon group, which may, in some examples, contain from 1 to about 50 carbon atoms, or 1 to about 40 carbon atoms, or 1 to about 30 carbon atoms, or 1 to about 10 carbon atoms, or 1 to about 5 carbon atoms for example.

As used herein, “alkyl”, or similar expressions such as “alk” in alkoxy, may refer to a branched, unbranched, or cyclic saturated hydrocarbon group, which may, in some examples, contain from 1 to about 50 carbon atoms, or 1 to about 40 carbon atoms, or 1 to about 30 carbon atoms, or 1 to about 10 carbon atoms, or 1 to about 5 carbon atoms for example.

The term “aryl” may refer to a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to about 50 carbon atoms, or 5 to about 40 carbon atoms, or 5 to 30 carbon atoms or more, and may be selected from, phenyl and naphthyl.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable as would be understood in the art.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a process for preparing a flexible packaging material. The process may comprise:
contacting a first flexible material of a layered substrate with an intermediate transfer member; wherein the layered substrate comprises the first flexible material and a thermally activatable laminating material disposed on the first flexible material;
transferring an electrophotographic ink composition from a photoimaging plate onto the thermally activatable laminating material of the layered substrate on the intermediate transfer member to form an image layer on the thermally activatable laminating material; and
contacting, under conditions of heat and/or pressure, the image layer with a second flexible material thereby forming the flexible packaging material.

In another aspect, there is provided a liquid electrophotographic printer. The liquid electrophotographic printer may comprise:
a photoimaging plate; and
an intermediate transfer member;
wherein the surface layer of the intermediate transfer member comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.

In a further aspect, the liquid electrophotographic printer may comprise:
a photoimaging plate; and
an intermediate transfer member;
wherein, in use, a first flexible material of a layered substrate is contacted with the intermediate transfer member; wherein the layered substrate comprises a first flexible material and a thermally activatable laminating material disposed on the first flexible material;
an electrophotographic ink composition is transferred from the photoimaging plate onto the thermally activatable laminating material of the layered substrate on the intermediate transfer member to form an image layer on the thermally activatable laminating material; and
the image layer is contacted with a second flexible material under conditions of heat and/or pressure thereby forming the flexible packaging material.

Currently, flexible packaging materials may be produced by reverse printing onto a first substrate and then laminating a second substrate onto the printed first substrate by applying an adhesive between the printed first substrate and the second substrate. This process requires multiple steps typically involving multiple pieces of machinery.

Firstly, images are printed onto the first substrate by using a printer. A laminating machine is then used to laminate the printed first substrate to the second substrate with an adhesive applied between the first and second substrate. Additionally, in many cases, curing of the adhesive takes several hours. The process of producing a flexible packaging material described herein has been shown to avoid or at least mitigate at least one of these problems.

### Process for Preparing a Flexible Packaging Material

In an aspect, there is provided a process for preparing a flexible packaging material. The process for preparing a flexible packaging material may comprise contacting a first flexible material of a layered substrate with an intermediate transfer member; wherein the layered substrate comprises the first flexible material and a thermally activatable laminating material disposed on the first flexible material; transferring an electrophotographic ink composition from a photoimaging plate onto the thermally activatable laminating material of the layered substrate on the intermediate transfer member to form an image layer on the thermally activatable laminating material; and contacting the image layer with a second flexible material thereby forming the flexible packaging material.

In some examples, contacting the first flexible material of a layered substrate with an intermediate transfer member comprises placing the layered substrate on the intermediate transfer member such that the first flexible material is disposed between the intermediate transfer member and the thermally activatable laminating material. In some examples, contacting the first flexible material of a layered substrate with an intermediate transfer member comprises temporarily adhering the first flexible material of the layered substrate to the intermediate transfer member. In some examples, temporarily adhering the first flexible material of the layered substrate to the intermediate transfer member is achieved by heating the intermediate transfer member, for example, to a temperature as described herein. The first flexible material of a layered substrate may be contacted with the intermediate transfer member in a manner which ensures that the first flexible material remains stationary with respect to the intermediate transfer member, that is, moves with the movement of the intermediate transfer member.

In some examples, one electrophotographic ink composition is transferred from a photoimaging plate onto the thermally activatable laminating material of the layered substrate on the intermediate transfer member to form an image layer on the thermally activatable laminating material. In some examples, a plurality of electrophotographic ink compositions are sequentially transferred onto the thermally activatable laminating material on the intermediate transfer member to form an image layer on the thermally activatable laminating material. In some examples, a plurality of electrophotographic ink compositions comprises at least two electrophotographic ink compositions, which may be selected from cyan electrophotographic ink, magenta electrophotographic ink, yellow electrophotographic ink, black electrophotographic ink (also referred to as key electrophotographic ink) and white electrophotographic ink. In some examples, other types of electrophotographic ink compositions, for example, metallic electrophotographic ink compositions, luminescent electrophotographic ink compositions, security ink compositions or magnetic electrophotographic ink compositions may also be used. In some examples, a plurality of electrophotographic ink compositions comprises cyan electrophotographic ink, magenta electrophotographic ink and yellow electrophotographic ink. In some examples, a plurality of electrophotographic ink compositions comprises cyan electrophotographic ink, magenta electrophotographic ink, yellow electrophotographic ink and black electrophotographic ink. In some examples, a plurality of electrophotographic ink compositions comprises cyan electrophotographic ink, magenta electrophotographic ink, yellow electrophotographic ink, black electrophotographic ink and white electrophotographic ink.

In some examples, the process comprises forming a latent image on the photoimaging plate, transferring the chargeable particles of the electrophotographic ink composition onto the photoimaging plate to form an image on the photoimaging plate and then transferring the electrophotographic ink composition (i.e., the image) from the photoimaging plate onto the thermally activatable laminating material of the layered substrate on the intermediate transfer member. In some examples, the latent image on the photoimaging plate comprises charged image areas and uncharged background areas, and the chargeable particles of the electrophotographic ink composition are attracted to the charged image areas on the photoimaging plate.

In some examples, the electrophotographic ink composition is transferred from the photoimaging plate onto the thermally activatable laminating material of the layered substrate on the intermediate transfer member to form the image layer on the thermally activatable laminating material by electrical forces, for example, a difference in potential between the photoimaging plate and the intermediate transfer member that attracts the chargeable particles of the electrophotographic ink composition towards the intermediate transfer member and into contact with the thermally activatable laminating material on the intermediate transfer member. In some examples, the potential difference may be at least about 450 V, for example, at least about 475 V, at least about 500 V, at least about 525 V, at least about 550 V, at least about 575 V, or at least about 600 V. In some examples, the potential difference may be up to about 600 V, for example, up to about 575 V, up to about 550 V, up to about 525 V, up to about 500 V, up to about 475 V, or up to about 450 V. In some examples, the potential difference may be about 450 V to about 600 V, for example, about 475 V to about 575 V, about 500 V to about 550 V, about 525 V to about 600 V. In some examples, the potential difference may be about 550 V.

In some examples, the thermally activatable laminating material is activated prior to transfer of the electrophotographic ink composition to the thermally activatable laminating material. In some examples, activating the thermally activatable laminating material increases the adhesion of the electrophotographic ink composition (for example, the chargeable particles of the electrophotographic ink composition) to the thermally activatable laminating material, improving transfer of the electrophotographic ink composition (for example, the chargeable particles of the electrophotographic ink composition) from the photoimaging plate to the thermally activatable laminating material of the layered substrate. In some examples, activation of the thermally activatable laminating material comprises heating the thermally activatable laminating material to a temperature above the melting point of the thermally activatable laminating material. In some examples, activation of the thermally activatable laminating material comprises heating the thermally activatable laminating material to a temperature of at least 5° C. above the melting point, for example, at least 6° C. above the melting point, at least 7° C. above the melting point, at least 8° C. above the melting point, at least 9° C. above the melting point, or at least 10° C. above the melting point of the thermally activatable laminating material. In some examples, activation of the thermally activatable laminating material comprises heating the thermally activatable material to a temperature of from 10° C. above the melting point to 5° C. above the melting point of the thermally activatable laminating material.

In some examples, the electrophotographic ink composition may be a liquid electro-photographic ink composition. In some examples, the carrier liquid of the liquid electrophotographic ink composition is at least partially evaporated while the layered substrate is in contact with the intermediate transfer member. In some examples, the carrier liquid of the liquid electrophotographic ink composition is at least partially evaporated after the liquid electrophotographic ink composition is transferred from the photoimaging plate onto the thermally activatable laminating material and before the image layer is contacted with the second flexible material. In some examples, the majority of the carrier liquid of the liquid electrophotographic ink compositions is evaporated while the layered substrate is in contact with the intermediate transfer member. In some examples, the majority of the carrier liquid of the liquid electrophotographic ink composition is evaporated after the liquid electrophotographic ink composition is transferred from the photoimaging plate onto the thermally activatable laminating material and before the image layer is contacted with the second flexible material. In some examples, a majority of the carrier liquid is at least 80 wt. % of the carrier liquid, for example, at least 85 wt. %, at least 90 wt. %, at least 95 wt. %, at least 96 wt. %, at least 97 wt. %, at least 98 wt. % or at least 99 wt. % of the carrier liquid. In some examples, a majority of the carrier liquid is from 80 wt. % to 99 wt. % of the carrier liquid, for example, 85 wt. % to 98 wt. %, 90 wt. % to 97 wt. %, 95 wt. % to 96 wt. % of the carrier liquid.

In some examples, the intermediate transfer member is heated. In some examples, the heating of the intermediate transfer member causes evaporation of the carrier liquid of the liquid electrophotographic ink compositions and/or causes the chargeable particles in the electrophotographic ink composition to form a film. In some examples, the intermediate transfer member is heated at a temperature of at least about 50° C., for example, at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., or at least about 150° C. In some examples, the intermediate transfer member is heated at a temperature below the melting point of the first flexible material. In some examples, the intermediate transfer member is heated at a temperature above the glass transition temperature (Tg) of the first flexible material of the layered substrate. In some examples, the intermediate transfer member is heated to a temperature that is high enough for the electrophotographic ink composition to transfer from the photoimaging plate to the thermally activatable laminating material of the layered substrate but low enough that the first flexible material of the layered substrate is not melted or otherwise damaged (for example, distorted or twisted) during the transfer of the electrophotographic ink composition. In some examples, the intermediate transfer member is heated at a temperature of up to about 150° C., for example, up to about 145° C., up to about 140° C., up to about 135° C., up to about 130° C., up to about 125° C., up to about 120° C., up to about 115° C., up to about 110° C., up to about 105° C., up to about 100° C., up to about 95° C., up to about 90° C., up to about 85° C., up to about 80° C., up to about 75° C., up to about 70° C., up to about 65° C., up to about 60° C., up to about or up to about 50° C. In some examples, the intermediate transfer member is heated at a temperature of from about 50° C. to about 150° C., for example, about 55° C. to about 150° C., about 60° C. to about 145° C., about 65° C. to about 140° C., about 70° C. to about 135° C., about 75° C. to about 130° C., about 80° C. to about 125° C., about 85° C. to about 120° C., about 90° C. to about 115° C., about 95° C. to about 110° C., or about 100° C. to about 105° C.

The melting point may be determined by differential scanning calorimetry, for example, using ASTM D3418 (for example, using a heating rate of 10° C./min).

The glass transition temperature may be measured by differential scanning calorimetry by following ASTM E1356 and using a heating rate of, for example, 10° C./min.

In some examples, heated air is applied (for example, by IR lamps) to the image layer on the thermally activatable laminating material on the intermediate transfer member. In some examples, the heated air evaporates the carrier liquid of the liquid electrophotographic ink composition. In some examples, the heated air causes the chargeable particles in the electrophotographic ink composition to form a film. In some examples, the heated air is at a temperature of at least about 40° C., for example, at least about 45° C., at least about 50° C., at least about 55° C., at least about 60° C., at least about 65° C., at least about 70° C., at least about 75° C., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., or at least about 140° C. In some examples, the heated air is at a temperature of up to about 140° C., for example, up to about 135° C., up to about 130° C., up to about 125° C., up to about 120° C., up to about 115° C., up to about 110° C., up to about 105° C., up to about 100° C., up to about 95° C., up to about 90° C., up to about 85° C., up to about 80° C., up to about 75° C., up to about 70° C., up to about 65° C., up to about 60° C., up to about 55° C., up to about 50° C., up to about 45° C., or up to about 40° C. In some examples, the heated air is at a temperature of from about 40° C. to about 140° C., for example, about 45° C. to about 140° C., about 50° C. to about 135° C., about 55° C. to about 130° C., about 60° C. to about 125° C., about 65° C. to about 120° C., about 70° C. to about 115° C., about 75° C. to about 110° C., about 80° C. to about 105° C., about 85° C. to about 100° C., or about 90° C. to about

In some examples, the intermediate transfer member is heated and heated air is applied to the image layer on the thermally activatable laminating material on the intermediate transfer member. In some examples, the heated air may be at a higher temperature than the intermediate transfer member. In some examples, the temperature of the heated air may be at least about 5° C. higher than the temperature of the intermediate transfer member (ITM), for example, at least about 10° C. higher, at least about 15° C. higher, at least about 20° C. higher, at least about 25° C. higher than the temperature of the ITM. In some examples, the temperature of the heated air may be up to 25° C. higher than the temperature of the ITM, for example, up to about 20° C. higher, up to about 15° C. higher, up to about 10° C. higher, up to about 5° C. higher than the temperature of the ITM. In some examples, the temperature of the heated air may be from about 5° C. to about 25° C. higher than the temperature of the ITM, for example, about 10° C. to about 20° C. higher, about 15° C. to 20° C. higher than the temperature of the ITM.

In some examples, the image layer is contacted with the second flexible material under heat and/or pressure. In some examples, the image is contacted with the second flexible material under heat and pressure. In some examples, the heat activates the thermally activatable laminating material, thereby forming the flexible packaging material. In some examples, activating the thermally activatable laminating material comprises softening, in some examples, melting, the thermally activatable laminating material. In some examples, the conditions of heat and/or pressure comprise heating to a temperature below the melting point of the first flexible material.

In some examples, the image layer is contacted with the second flexible material at a temperature of at least about 50° C., for example, at least about 55° C., at least about at least about 65° C., at least about 70° C., at least about 75° C., at least about at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., or at least about 150° C. In some examples, the image layer is contacted with the second flexible material at a temperature of up to about 150° C., for example, up to about 145° C., up to about 140° C., up to about 135° C., up to about 130° C., up to about 125° C., up to about 120° C., up to about 115° C., up to about 110° C., up to about 105° C., up to about 100° C., up to about 95° C., up to about 90° C., up to about 85° C., up to about 80° C., up to about 75° C., up to about 70° C., up to about up to about 60° C., up to about 55° C., or up to about 50° C. In some examples, the image layer is contacted with the second flexible material at a temperature in the range of 50° C. to 150° C. for example, about 55° C. to about 150° C., about 60° C. to about 145° C., about 65° C. to about 140° C., about 70° C. to about 135° C., about 75° C. to about 130° C., about 80° C. to about 125° C., about 85° C. to about 120° C., about 90° C. to about 115° C., about 95° C. to about 110° C., or about 100° C. to about 105° C. It would be understood that the temperature required for efficient thermal lamination will depend on the nature or composition of the thermally activatable laminating material and/or the thermoplastic polymer of the electrographic ink composition and associated melting temperatures.

In some examples, the pressure is at least about 10 kg of pressure, for example, at least about 15 kg, at least about 20 kg, at least about 25 kg, at least about 30 kg, at least about 35 kg, at least about 40 kg, at least about 45 kg, at least about 50 kg of pressure. In some examples, the pressure is up to about 50 kg of pressure, for example, up to about 45 kg, up to about 40 kg, up to about 35 kg, up to about 30 kg, up to about 25 kg, up to about 20 kg, up to about 15 kg, up to about 10 kg of pressure. In some examples, the pressure is from about 10 kg to about 50 kg, for example, about 15 kg to about 45 kg, about 20 kg to about 40 kg, about 25 kg to about 35 kg, about 25 kg to about 30 kg.

In some examples, a primer is applied to the second flexible material before the second flexible material is contacted with the image layer. If present, the primer is disposed on the surface of the second flexible material that contacts the image layer. Thus, image layer contacts the primer disposed on the second flexible material. In some examples, the primer is dried before the second flexible material is contacted with the image layer. In some examples, drying the primer comprises heating the primer. In some examples, the heating is at a temperature of at least about 40° C., for example, at least about 45° C., at least about 50° C., at least about 55° C., at least about 60° C., at least about 65° C., at least about 70° C., at least about 75° C., at least about 80° C. In some examples, the heating is at a temperature of up to about 80° C., for example, up to about 75° C., up to about 70° C., up to about 65° C., up to about 60° C., up to about 55° C., up to about 50° C., up to about 45° C., up to about 40° C. In some examples, the heating is at a temperature of from about 40° C. to about 80° C., for example, about 45° C. to about 75° C., about 50° C. to about 70° C., about 55° C. to about 65° C., about 60° C. to about 80° C.

In some examples, the surface of the intermediate transfer member, that is, the surface that contacts the first flexible material, comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.

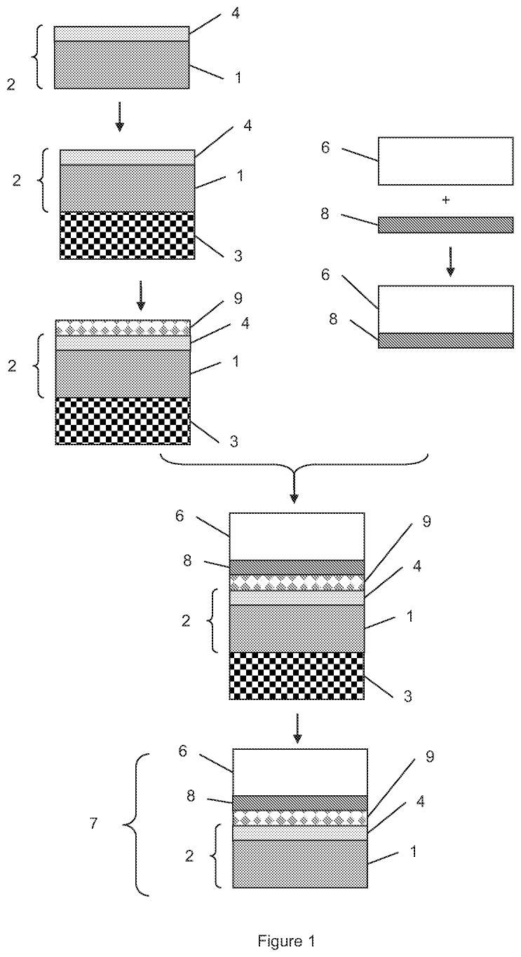

FIG. 1 depicts a process in which a layered substrate 2 is contacted with an intermediate transfer member 3. The layered substrate comprises a first flexible material 1 and a thermally activatable laminating material 4, wherein the first flexible material 1 contacts the intermediate transfer member 3. An electrophotographic ink composition is transferred from a photoimaging plate (not shown) onto the thermally activatable laminating material 4 of the layered substrate 2 on the ITM 3 to form an image layer 9. In some examples, a plurality of electrophotographic ink compositions are sequentially transferred onto the thermally activatable laminating material 4 of the layered substrate 2 on the ITM 3 to form the image layer 9.

A primer 8 is applied to a second flexible substrate 6. The image layer 9 is then contacted with the second flexible substrate 6 with the primer 8 disposed between the image layer 9 and the second flexible substrate 6, to form a flexible packaging material 7. In some examples, no primer 8 is used. The flexible packaging material 7 is removed from the ITM 3.

### Electrophotopraphic Printer

In another aspect, there is provided an electrophotographic printer, for example, a liquid electrophotographic printer. The electrophotographic printer, for example, the liquid electrophotographic printer, may comprise a photoimaging plate and an intermediate transfer member.

In some examples, the surface layer of the intermediate transfer member comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.

In some examples, in use, the liquid electrophotographic printer performs the process described herein. In some examples, the liquid electrophotographic printer comprises a photoimaging plate and an intermediate transfer member; wherein, in use, a first flexible material of a layered substrate is contacted with the intermediate transfer member; wherein the layered substrate comprises a first flexible material and a thermally activatable laminating material disposed on the first flexible material; an electrophotographic ink composition is transferred from the photoimaging plate onto the thermally activatable laminating material of the layered substrate on the intermediate transfer member to form an image layer on the thermally activatable laminating material; and the image layer is contacted with a second flexible material under conditions of heat and/or pressure thereby forming the flexible packaging material.

### Intermediate Transfer Member

In some examples, the intermediate transfer member may be termed an ITM herein for brevity. In some examples, the surface layer of the intermediate transfer member comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.

In some examples, the surface layer of the intermediate transfer member comprises an acrylic rubber. In some examples, the acrylic rubber comprises a copolymer of an alkylene monomer and a monomer selected from an alkyl ester of acrylic acid and an alkyl ester of methacrylic acid. In some examples, the acrylic rubber comprises a copolymer of an alkylene monomer; a monomer selected from an alkyl ester of acrylic acid and an alkyl ester of methacrylic acid; and at least one additional monomer. In some examples, the acrylic rubber comprises a copolymer formed by polymerisation of an alkylene monomer, a monomer selected from alkyl esters of acrylic acid and alkyl esters of methacrylic acid and another monomer, for examples, an alkyl halide monomer or a carboxylic acid containing monomer.

In some examples, the alkylene monomer may be selected form ethylene and propylene. In some examples, the alkylene monomer may be ethylene.

In some examples, the alkyl ester of acrylic acid may be a C1 to C10 alkyl ester of acrylic acid. In some examples, the alkyl ester of acrylic acid may be a linear alkyl ester of acrylic acid, a branched alkyl ester of acrylic acid or a cyclic ester of acrylic acid. In some examples, the alkyl ester of acrylic acid may be selected from methyl acrylate, ethyl acrylate, propyl acrylate, methylpropyl acrylate, butyl acrylate, methylbutyl acrylate, hexyl acrylate, ethylbutyl acrylate, and heptyl acrylate. In some examples, the alkyl ester of acrylic acid may be ethylbutyl acrylate.

In some examples, the alkyl ester of methacrylic acid may be a C1 to C10 alkyl ester of methacrylic acid. In some examples, the alkyl ester of methacrylic acid may be a linear alkyl ester of methacrylic acid, a branched alkyl ester of methacrylic acid or a cyclic ester of methacrylic acid. In some examples, the alkyl ester of methacrylic acid may be selected from methyl methacrylate, ethyl methacrylate, propyl methacrylate, methylpropyl methacrylate, butyl acrylate, methacrylate acrylate, hexyl methacrylate, ethylbutyl methacrylate, and heptyl methacrylate. In some examples, the alkyl ester of acrylic acid may be ethylbutyl methacrylate.

In some examples, the acrylic rubber may comprise a random copolymer of alkyl halide monomers, carboxylic acid monomers, alkylene monomers and acrylate monomers. In some examples, the surface layer of the intermediate transfer member comprises a random copolymer of alkyl halide monomers, carboxylic acid monomers, alkylene monomers and acrylate monomers.

In some examples, the alkyl halide monomer may be selected from haloalkyl esters of acrylic acid and haloalkyl esters of methacrylic acid. In some examples, the haloalkyl ester of acrylic acid may be a chloroalkyl ester of acrylic acid. In some examples, the haloalkyl ester of methacrylic acid may be a chloroalkyl ester of methacrylic acid. In some examples, the chloroalkyl ester of acrylic acid or methacrylic acid may be formed by the esterification of acrylic acid or methacrylic acid with a chloroalcohol selected from C1 to C10 chloroalcohols, for example, chloromethanol, chloroethanol (e.g., 2-chloroethanol), chloropropanol (e.g., 3-chloropropanol), chlorobutanol, (e.g., 4-chlorobutanol), chloropentanol (e.g., 5-chloropentanol), chlorohexanol (e.g., 6-chlorohexanol) and chloroheptanol (e.g., 7-chloroheptanol).

In some examples, the carboxylic acid monomers may be an alkenoic acid, for example, a C1 to C10 alkenoic acid, such as acrylic acid (prop-2-enoic acid), methacrylic acid (2-methylprop-2-enoic acid), butenoic acid (e.g., but-2-enoic acid), pentenoic acid (e.g., pent-2-enoic acid), hexenoic acid (e.g., hex-2-enoic acid), and heptenoic acid (e.g., hept-2-enoic acid).

In some examples, the surface layer of the ITM is not a release layer. In some examples, the surface layer of the ITM does not have release properties. In some examples, silicones, for example, polyalkylsiloxanes are absent from the surface layer of the ITM.

In some examples, the surface layer may comprise have a Shore A hardness value of less than about 65, or a Shore A hardness value of less than about 55 and greater than about 35, or a Shore A hardness value of between about 42 and about 45. In some examples, the surface layer comprises a polyurethane, a thermoplastic polyurethane or an acrylic. Shore A hardness is determined by ASTM standard D2240.

In some examples, the intermediate transfer member may comprise a supportive portion on which the surface layer is disposed. The supportive portion may be termed an intermediate transfer member body herein.

The ITM may have a base, for example, a metal base. The base may have a cylindrical shape. The base may form part of the supportive portion of the ITM.

The ITM may have a cylindrical shape; as such, the ITM may be suitable for use as a roller.

The supportive portion of the ITM may comprise a layered structure disposed on the base of the ITM. The supportive portion may comprise a layer comprising a thermoplastic polyurethane.

The layered structure may comprise a compliant substrate layer, for example, a rubber layer or a layer comprising a thermoplastic polyurethane, on which the surface layer may be disposed. The compliant substrate layer may comprise a thermoplastic polyurethane layer or a rubber layer. The rubber layer may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (e.g., FMQ or FLS), a fluorocarbon rubber (e.g., FKM or FPM) or a perfluorocarbon rubber (e.g., FFKM).

In some examples, the ITM may comprise an adhesive layer for joining the compliant substrate layer to the base. The adhesive layer may be a fabric layer, for example, a woven or non-woven cotton, synthetic, combined natural and synthetic, or treated, for example, treated to have improved heat resistance, material.

The compliant substrate layer may be formed of a plurality of compliant layers. For example, the compliant substrate layer may comprise a compressible layer and a conductive layer. A “conductive layer” may be a layer comprising electrically conductive particles. In some examples, any one or more of the plurality of compliant layers may comprise a thermoplastic polyurethane.

In some examples, the compressible layer is disposed on the base of the ITM. The compressible layer may be joined to the base of the ITM by the adhesive layer. A conductive layer may be disposed on the compressible layer. The surface layer may then be disposed on the conductive layer, if present, or disposed on the compressible layer if no conductive layer is present. If the compressible layer and/or the surface layer are partially conducting there may be no requirement for an additional conductive layer.

The compressible layer may have a large degree of compressibility. In some examples, the compressible layer may be 600 μm thick.

The compressible layer may comprise a thermoplastic polyurethane layer, a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). In some examples, the compressible layer may comprise carbon black to increase its thermal conductivity.

In some examples, the compressible layer includes small voids, which may be as a result of microspheres or blowing agents used in the formation of the compressible layer. In some examples, the small voids comprise about 40% to about 60% by volume of the compressible layer.

In an example the compressible layer and the surface layer are formed from the same material.

The conductive layer may comprise a rubber, for example, an acrylic rubber (ACM), a nitrile rubber (NBR), a hydrogenated nitrile rubber (HNBR), or an EPDM rubber (an ethylene propylene diene terpolymer), and one or more conductive materials, including but not limited to carbon black or metallic particles. In some examples, the conductive layer may comprise a thermoplastic polyurethane and one or more conductive materials, including but not limited to carbon black or metallic particles. In some examples, the conductive layer may be omitted, such as in some examples, in which the compressible layer and/or the surface layer are partially conducting. For example, the compressible layer and/or the compliance layer may be made to be partially conducting with the addition of conductive carbon black or metal fibres.

In some examples, the compressible layer and/or the surface layer may be made to be partially conducting with the addition of conducting particles, for example, conductive carbon black, metal particles or metal fibres. In some examples, where the compressible layer and/or the compliance layer are partially conducting there may be no requirement for an additional conductive layer.

In some examples, the intermediate transfer member comprises, in the following order:
a. a fabric layer;
b. a compressible layer, which may have voids therein;
c. a layer comprising electrically conductive particles; and
d. a surface layer.

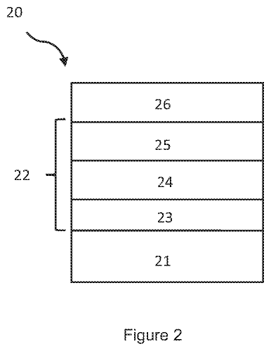

FIG. 2 is a cross-sectional diagram of an example of an ITM. The ITM 20 includes a supportive portion comprising a base 21 and a substrate layer 22 disposed on the base. The base 21 may be a metal cylinder. The substrate layer 22 may comprise or be a nitrile rubber. The substrate layer 22 may comprise a fabric layer 23, a compressible layer 24, which may have voids therein, and a layer 25 comprising electrically conductive particles. The ITM also comprises a surface layer 26 disposed on the substrate layer 22.

### Flexible Packaging Material

In some examples, the process produces a flexible packaging material. Each component of the flexible packaging material will be discussed in the sections which follow.

In some examples, the flexible packaging material comprises, in the following order:
a. a first flexible material;
b. a thermally activatable laminating material;
c. an image layer;
d. optionally, a primer; and
e. a second flexible material.

In some examples, the flexible packaging material comprises a laminate structure with sufficient bond strength to avoid delamination of the layers, in particular delamination at the interface between the layer of thermally activatable laminating material and the second flexible material.

In some examples, at least one of the first flexible material and the second flexible material is transparent. In some examples, the first flexible material and the second flexible material are transparent. In some examples, the first flexible material is transparent. In some examples, the second flexible material is transparent.

### Layered Substrate

The layered substrate may comprise a first flexible material and a thermally activatable laminating material. In some examples, the layered substrate may comprise further layers disposed between the first flexible material and the thermally activatable laminating material. In some examples, the layered substrate consists of a first flexible material and a thermally activatable laminating material. In some examples, the material is transparent in order that the image is visible to the consumer through the material.

### First Flexible Material

In some examples, the first flexible material may be any material suitable for use in a printing process and suitable for use in a flexible packaging material. The first flexible material can be a non-conductive material.

In some examples, the first flexible material comprises a polymer, for example, a film of a polymer. In some examples, the first flexible material comprises a thermoplastic polymer. In some examples, the first flexible material comprises biaxially oriented polypropylene (BOPP), polyethylene terephthalate (PET) or cast PP (CPP). In some examples, the PET may comprise PET-silicon oxide, PET-PVOH or PET-PVDC.

In some examples, the first flexible material of the flexible packaging material may be the innermost layer of the flexible packaging material in use. In some examples, the first flexible material may be referred to as a functional substrate. In some examples, the functional substrate may be functional in the sense that it provides a barrier function to protect the packaged goods. in some examples, the first flexible material may serve as a barrier to any external influence that could damage or otherwise reduce the quality of the packaged goods, in particular food, by preventing ingress of, for example, moisture, oxygen, other oxidants and pathogens such as viruses and bacteria.

In some examples, the first flexible material comprises a film or sheet, e.g. a thin film or sheet, of paper and/or plastic. In some examples, the first flexible material comprises a paper substrate. In some examples, the first flexible material is a polymeric first flexible material. In some examples the first flexible material comprises a film of a plastic material, for example, polyethylene (PE), linear low density polyethylene (LLDPE), low density polyethylene (LDPE), polypropylene (PP), biaxial oriented polypropylene (BOPP), cast polypropylene (CPP) or polyethylene terephthalate.

In some examples, the first flexible material comprises a plurality of layers of film of material laminated together to form a pre-laminated flexible material. In some examples, the first flexible material comprises a plurality of layers of material selected from polymeric materials (e.g. polymeric materials selected from PE, LLDPE, MDPE, PP, BOPP, PET and OPA), paper and combinations thereof. In some examples, the first flexible material comprises a plurality of layers of film of a plastic material, such as a combination of films selected from PE, LLDPE, MDPE, PP, BOPP, PET and OPA, laminated together to form the pre-laminated flexible material. In some examples, the pre-laminated flexible material comprises a PET/PE laminate.

In some examples, the first flexible material comprises a film of a polymer, wherein the film is less than 50 μm in thickness, for example less than 45 μm in thickness, for example less than 40 μm in thickness, for example less than 35 μm in thickness, for example less than 30 μm in thickness, for example less than 25 μm in thickness, for example less than 20 μm in thickness, for example less than 15 μm in thickness, for example less than 13 μm in thickness, for example less than 12 μm in thickness. In some examples, the film of polymer is about 12 μm in thickness.

In some examples, the first flexible material comprises a film of a polymer, wherein the film is greater than 9 μm in thickness, for example greater than 12 μm in thickness, for example greater than 15 μm in thickness, for example greater than 20 μm in thickness, for example greater than 25 μm in thickness, for example greater than 30 μm in thickness, for example greater than 35 μm in thickness, for example greater than 40 μm in thickness, for example greater than 45 μm in thickness, for example greater than 50 μm in thickness.

### Thermally Activatable Laminating Material

In some examples, the thermally activatable laminating layer comprises a polymer resin, for example, a thermoplastic polymer resin. In some examples, the thermally activatable laminating layer comprises a low melting polymer. The term “low melting polymer” is to be understood as a polymeric material which is solid at room temperature but melts at a temperature typically obtainable in an electrophotographic printer.

In some examples, the thermally activatable laminating material comprises a low melting polymer with a melting point of about 140° C. or less, for example, about 130° C. or less, about 120° C. or less, about 110° C. or less, about 100° C. or less, about 95° C. or less, about 90° C. or less, about 85° C. or less, about 80° C. or less, about 75° C. or less, about 70° C. or less, or about 65° C. or less. In some examples, the thermally activatable laminating material comprises a low melting polymer with a melting point of about 65° C. or more, for example, about 70° C. or more, about 75° C. or more, about 80° C. or more, about 85° C. or more, about 90° C. or more, about 95° C. or more, about 100° C. or more, about 110° C. or more, about 120° C. or more, about 130° C. or more, about 140° C. or more. In some examples, the thermally activatable laminating material comprises a low melting polymer with a melting point of from about 65° C. to about 140° C., for example, about 70° C. to about 130° C., about 75° C. to about 120° C., about 80° C. to about 110° C., about 85° C. to about 100° C., about 65° C. to about 95° C., about 70° C. to about 90° C.

By using a low melting polymer as the thermally activatable laminating material it becomes possible to adhere the first flexible material to the second flexible material at the temperatures used in an electrophotographic printer, for example, the temperature of the intermediate transfer member.

In some examples, the thermally activatable laminating material comprises a thin film of a polymer, wherein the film is less than 50 μm in thickness, for example, less than 40 μm in thickness, less than 30 μm in thickness, less than 20 μm in thickness, less than 15 μpm, less than 14 μm in thickness, less than 13 μm in thickness, less than 12 μm in thickness, less than 11 μm in thickness, less than 10 μm in thickness, less than 8 μm in thickness. In one example, the film of polymer is about 13 μm in thickness.

In some examples, the thermally activatable laminating layer or material comprises a thin film of a polymer, wherein the film is greater than 8 μm in thickness, for example greater than 10 μm in thickness, greater than 11 μm in thickness, greater than 12 μm in thickness, greater than 13 μm in thickness, greater than 14 μm in thickness, greater than 15 μm in thickness, greater than 20 μm in thickness, greater than 30 μm in thickness, greater than 40 μm in thickness, greater than 50 μm in thickness.

In some examples, the thermally activatable laminating material comprises a copolymer of an alkylene monomer (for example, ethylene or propylene) and a monomer selected from alkenyl esters (e.g., vinyl acetate), acrylates and methacrylates. In some examples, the thermally activatable laminating material comprises a copolymer selected from ethylene vinyl acetate (EVA) and ethylene methyl acrylate (EMA).

In some examples, the polymer may be selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %), and alkyl (e.g. C1 to C5) ester of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers, urethane polymers and combinations thereof. In some examples, the polymer may be an ethylene vinyl acetate copolymer.

The thermally activatable laminating material may comprise a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The thermally activatable laminating material may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example, as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt. % to about 25 wt. % of the co-polymer, in some examples from 10 wt. % to about 20 wt. % of the co-polymer.

The thermally activatable laminating material may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg

KOH/g, and a second polymer having acidic side groups that has an acidity of 110 mg KOH/g to 130 mg KOH/g.

The thermally activatable laminating material may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The thermally activatable laminating material may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the thermally activatable laminating material comprises a single type of polymer, the polymer may have a melt viscosity of 6000 poise or more, in some examples a melt viscosity of 8000 poise or more, in some examples a melt viscosity of 10000 poise or more, in some examples a melt viscosity of 12000 poise or more. If the thermally activatable laminating material comprises a plurality of polymers all the polymers may together form a mixture that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The thermally activatable laminating material may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN ionomers. The thermally activatable laminating material may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the co-polymer, in some examples 10 wt. % to 16 wt. % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the co-polymer, in some examples from 14 wt. % to about 20 wt. % of the co-polymer, in some examples from 16 wt. % to about 20 wt. % of the co-polymer in some examples from 17 wt. % to 19 wt. % of the co-polymer.

The thermally activatable laminating material may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The thermally activatable laminating material may comprise a thermoplastic polyurethane. Thermoplastic polyurethanes are formed during a polyaddition reaction between a diisocyanate, a polyol or long-chain diol and a chain extender or short-chain diol. Suitable thermoplastic polyurethanes include the Irogran®, Avalon®, Krystalgran® and Irostic® families available from Huntsman, and the Pureseal family of polymers from Ashland.

The thermoplastic polyurethane may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the thermally activatable laminating material can in some examples be selected from the Nucrel family of polymers (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the AC family of polymers (e.g. AC-5120, AC-5180, AC-540, AC-580 (sold by Honeywell)), the Aclyn family of polymers (e.g. Aclyn 201, Aclyn 246, Aclyn 285, and Aclyn 295), the Lotader family of polymers (e.g. Lotader 2210, Lotader, 3430, and Lotader 8200 (sold by Arkema)), the Lotryl family of polymers (e.g. Lotryl MA03 (sold by Arkema)), the Escor family of polymers (e.g. Escor 5020 7.5% (sold by Exxon Mobil), the Tafmer family of polymers (e.g. Tafmer MA9015 (sold by Mitsui)) and the Surlyn family of polymers (e.g. Surlyn 1652 (sold by DuPont)).

### Electrophotooraphic Ink Composition

The electrophotographic ink composition, for example, the liquid electrophotographic printing composition (also referred to herein as a LEP composition), useful in the methods described herein to form flexible packaging materials also described generally comprises a colorant or pigment, a thermoplastic resin and a carrier fluid or liquid. The LEP composition may further comprise one or more additives such as charge directors, charge adjuvants, surfactants, viscosity modifiers, emulsifiers and the like. In some examples, the LEP composition may not contain any pigment, or comprise substantially zero pigment and thus be a pigment-free composition, useful in providing a particular transparent gloss or sheen to a printed substrate.

Each of these components will be described separately in the sub-sections which follow.

### Thermoplastic Resin

In some examples, the electrophotographic ink composition, for example, the liquid electrophotographic ink composition comprises a thermoplastic resin. In some examples, the thermoplastic resin may comprise a polymer having acidic side groups. A thermoplastic polymer is sometimes referred to as a thermoplastic resin or a polymer resin.

In some examples, the LEP ink composition comprises chargeable particles (i.e., having or capable of developing a charge, for example, in an electromagnetic field) including the thermoplastic resin and, in some examples, a colorant.

In some examples, the thermoplastic resin comprises a copolymer of an alkylene monomer and a monomer selected from acrylic acid and methacrylic acid. In some examples, the polymer may comprise one or more of ethylene or propylene acrylic acid co-polymers; ethylene or propylene methacrylic acid co-polymers; ethylene vinyl acetate co-polymers; co-polymers of ethylene or propylene (e.g. 80 wt. % to 99.9 wt. %), and alkyl (e.g. C1 to C5) ester of methacrylic or acrylic acid (e.g. 0.1 wt. % to 20 wt. %); co-polymers of ethylene (e.g. 80 wt. % to 99.9 wt. %), acrylic or methacrylic acid (e.g. 0.1 wt. % to 20.0 wt. %) and alkyl (e.g. C1 to C5) ester of methacrylic or acrylic acid (e.g. 0.1 wt. % to 20 wt. %); co-polymers of ethylene or propylene (e.g. 70 wt. % to 99.9 wt. %) and maleic anhydride (e.g. 0.1 wt. % to 30 wt. %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50 wt. % to 90 wt. %)/methacrylic acid (e.g. 0 wt. % to wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

In some examples, the thermoplastic resin comprises a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The thermoplastic resin may comprise a polymer having acidic side groups that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt. % to about 25 wt. % of the co-polymer, in some examples, from 10 wt. % to about 20 wt. % of the co-polymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The thermoplastic resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The thermoplastic resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The thermoplastic resin may comprise a first polymer having a melt viscosity of 15000 poise or more, in some examples 20000 poise or more, in some examples 50000 poise or more, in some examples 70000 poise or more; and in some examples, the thermoplastic resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The thermoplastic resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the thermoplastic resin comprises a single type of polymer, the polymer (excluding any other components of the electrophotographic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the thermoplastic resin comprises a plurality of polymers all the polymers of the thermoplastic resin may together form a mixture (excluding any other components of the electrophotographic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The thermoplastic resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The thermoplastic resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the co-polymer, in some examples 10 wt. % to 16 wt. % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the co-polymer, in some examples from 14 wt. % to about 20 wt. % of the co-polymer, in some examples from 16 wt. % to about wt. % of the co-polymer in some examples from 17 wt. % to 19 wt. % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the liquid electrophotographic ink composition and/or the image layer, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the liquid electrophotographic composition and/or the image layer. The polymer having ester side groups may constitute from 5% to 50% by weight of the total amount of the resin polymers, e.g. thermoplastic resin polymers, in the liquid electrophotographic composition and/or the image layer, in some examples 10% to 40% by weight of the total amount of the resin polymers, e.g. thermoplastic resin polymers, in the liquid electrophotographic composition and/or image layer, in some examples 5% to 30% by weight of the total amount of the resin polymers, e.g. thermoplastic resin polymers, in the liquid electrophotographic composition and/or the image layer, in some examples 5% to 15% by weight of the total amount of the resin polymers, e.g. thermoplastic resin polymers, in the liquid electrophotographic composition and/or the image layer, in some examples 15% to 30% by weight of the total amount of the resin polymers, e.g. thermoplastic resin polymers, in the liquid electrophotographic composition and/or the image layer.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the AC family of toners (e.g. AC-5120, AC-5180, AC-540, AC-580 (sold by Honeywell)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The thermoplastic resin can constitute about 5 to 90%, in some examples about 50 to %, by weight of the solids of the liquid electrophotographic composition and/or the image layer. The resin can constitute about 60 to 95%, in some examples about 70 to %, by weight of the solids of the liquid electrophotographic composition and/or image layer.

### Colorant

In some examples, the electrophotographic ink composition comprises a colorant. The colorant may be a dye or pigment. The colorant can be any colorant compatible with the liquid carrier and useful for electrophotographic printing. For example, the colorant may be present as pigment particles, or may comprise a resin (in addition to the polymers described herein) and a pigment. The resins and pigments can be any of those commonly used as known in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200.

In some examples, the colorant or pigment particles may have a median particle size or d₅₀ of less than 20 μm, for example less than 15 μm, for example less than 10 μm, for example less than 5 μm, for example less than 4 μm, for example less than 3 μm, for example less than 2 μm, for example less than 1 μm, for example less than 0.9 μm, for example less than 08 μm, for example less than 0.7 μm, for example less than 0.6 μm, for example less than 0.5 μm. Unless otherwise stated, the particle size of the colorant or pigment particle and the resin coated pigment particle is determined using laser diffraction on a Malvern Mastersizer 2000 according to the standard procedure as described in the operating manual.

The colorant or pigment particle may be present in the method and/or electrostatic ink composition in an amount of from 10 wt. % to 80 wt. % of the total amount of resin and pigment, in some examples 15 wt. % to 80 wt. %, in some examples 15 wt. % to 60 wt. %, in some examples 15 wt. % to 50 wt. %, in some examples 15 wt. % to 40 wt. %, in some examples 15 wt. % to 30 wt. % of the total amount of resin and colorant. In some examples, the colorant or pigment particle may be present in the method and/or electrostatic ink composition in an amount of at least 50 wt. % of the total amount of resin and colorant or pigment, for example at least 55 wt. % of the total amount of resin and colorant or pigment.

### Carrier Liquid

In some examples, the LEP composition comprises thermoplastic resin coated pigment particles, or resin particles, which are formed in and/or dispersed in a carrier fluid or carrier liquid. Before transfer from the photoimaging plate onto the thermally activatable laminating material of the layered substrate on the intermediate transfer member, the composition may be an electrophotographic ink composition, which may be in dry form, for example in the form of flowable pigment particles coated with the thermoplastic resin. Alternatively, before transfer from the photoimaging plate onto the thermally activatable laminating material of the layered substrate on the intermediate transfer member, the electrophotographic ink composition may be in liquid form; and may comprise a carrier liquid in which is suspended pigment particles coated with the thermoplastic resin.

Generally, the carrier liquid acts as a reaction solvent in preparing the coated pigment particles, and can also act as a dispersing medium for the other components in the resulting electrophotographic ink composition. In one example, the carrier liquid is a liquid which does not dissolve the thermoplastic resin at room temperature. In one example, the carrier liquid is a liquid which dissolves the thermoplastic resin at elevated temperatures. For example, the thermoplastic resin may be soluble in the carrier liquid when heated to a temperature of at least 80° C., for example 90° C., for example 100° C., for example 110° C., for example 120° C. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm·cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In particular, the carrier liquids can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140υ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ TM (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

Before printing (i.e., before transfer of the electrophotographic ink composition from a photoimaging plate onto the thermally activatable laminating material of the layered substrate on the ITM), the carrier liquid can constitute about 20% to 99.5% by weight of the electrostatic ink composition, in some examples 50% to 99.5% by weight of the electrostatic ink composition. Before printing (i.e., before transfer of the electrophotographic ink composition from a photoimaging plate onto the thermally activatable laminating material of the layered substrate on the ITM), the carrier liquid may constitute about 40 to 90% by weight of the electrostatic ink composition. Before printing (i.e., before transfer of the electrophotographic ink composition from a photoimaging plate onto the thermally activatable laminating material of the layered substrate on the ITM), the carrier liquid may constitute about 60% to 80% by weight of the electrostatic ink composition. Before printing (i.e., before transfer of the electrophotographic ink composition from a photoimaging plate onto the thermally activatable laminating material of the layered substrate on the ITM), the carrier liquid may constitute about 90% to 99.5% by weight of the electrostatic ink composition, in some examples 95% to 99% by weight of the electrostatic ink composition.

The electrophotographic ink, when disposed between the thermally activatable laminating material and the second flexible material (i.e., when part of the flexible packaging material), may be substantially free from carrier liquid. During the process for preparing the flexible packaging material, the carrier liquid may be removed, e.g. by an electrophoresis processes (for example, during transfer of the electrophotographic ink composition from the photoimaging plate onto the thermally activatable laminating material) and/or evaporation, such that the image layer is substantially just solids when the image layer is contacted with the second flexible material. Substantially free from carrier liquid may indicate that the electrophotographic ink composition contains less than 5 wt. % carrier liquid, in some examples, less than 2 wt. % carrier liquid, in some examples less than 1 wt. % carrier liquid, in some examples less than 0.5 wt. % carrier liquid. In some examples, the electrophotographic ink composition of the image layer when contacted with the second flexible material is free from carrier liquid.

### Charge Director

The liquid electrophotographic ink composition and/or the image layer of the flexible packaging material can comprise a charge director. A charge director can be added to an electrophotographic ink composition to impart a charge of a desired polarity and/or maintain sufficient electrostatic charge on the particles of an electrophotographic ink composition. The charge director may comprise ionic compounds, including, but not limited to, metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates. The charge director can impart a negative charge or a positive charge on the thermoplastic resin-containing particles of an electrophotographic ink composition.

The charge director can comprise a sulfosuccinate moiety of the general formula: [Rₐ—O—C(O)CH₂CH(SO₃⁻)C(O—O—R_{b}], where each of Rₐ and R_{b} is an alkyl group. In some examples, the charge director comprises nanoparticles of a simple salt and a sulfosuccinate salt of the general formula MAₙ, wherein M is a metal, n is the valence of M, and A is an ion of the general formula [Rₐ—O—C(O)CH₂CH(SO₃⁻)C(O—O—R_{b}], where each of Rₐ and R_{b} is an alkyl group. The sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 200 nm or less, in some examples 2 nm or more. Simple salts are salts that do not form micelles by themselves, although they may form a core for micelles with a micelle forming salt. The ions constructing the simple salts are all hydrophilic. The simple salt may comprise a cation selected from Mg, Ca, Ba, NH₄, tert-butyl ammonium, Li⁺, and Al⁺³, or from any sub-group thereof. The simple salt may comprise an anion selected from SO₄²⁻, PO³⁻, N₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof. The charge director may further comprise basic barium petronate (BBP).

In the formula [Rₐ—O—C(O)CH₂CH(SO₃⁻)C(O—O—R_{b}], in some examples, each of Rₐ and R_{b} is an aliphatic alkyl group. In some examples, each of Rₐ and R_{b} independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, Rₐ and R_{b} are the same. In some examples, at least one of Rₐ and R_{b} is C₁₃H₂₇. In some examples, M is Na, K, Cs, Ca, or Ba.

The charge director may comprise (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In an electrophotographic ink composition, the charge director can constitute about to 20%, in some examples 0.01 to 20% by weight, in some examples 0.01 to 10% by weight, in some examples 0.01 to 1% by weight of the solids of the electrostatic ink composition and/or image layer. The charge director can constitute about 0.001 to 0.15% by weight of the solids of the liquid electrophotographic ink composition and/or image layer, in some examples 0.001 to 0.15%, in some examples to 0.02% by weight of the solids of the liquid electrophotographic ink composition and/or image layer. In some examples, the charge director imparts a negative charge on the electrostatic ink composition. The particle conductivity may range from 50 to 500 pmho/cm, in some examples from 200-350 pmho/cm.

### Charge Adjuvant

The liquid electrophotographic ink composition and/or image layer can include a charge adjuvant. A charge adjuvant may be present with a charge director, and may be different to the charge director, and act to increase and/or stabilise the charge on particles, e.g. resin-containing particles, of an electrostatic ink composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di- and/or tristearate and/or aluminium di- and/or tripalmitate.

The charge adjuvant can constitute about 0.1 to 5% by weight of the solids of the liquid electrophotographic ink composition and/or the image layer. The charge adjuvant can constitute about 0.5 to 4% by weight of the solids of the liquid electrophotographic ink composition and/or the image layer. The charge adjuvant can constitute about 1 to 3 by weight of the solids of the liquid electrophotographic ink composition and/or the image layer.

### Other Additives

The electrophotographic ink composition may include an additive or a plurality of additives. The additive or plurality of additives may be added at any stage of the method. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket.

### Second Flexible Material

In some examples, the second flexible material may be any material suitable for use in a printing process and suitable for use in a flexible packaging material.

In some examples, the second flexible material comprises one or more of paper, metallic foil, and a polymeric substrate.

In some examples, the second flexible material comprises a polymer, for example, a film of a polymer. In some examples, the second flexible material comprises a thermoplastic polymer. In some examples, the second flexible material comprises biaxially oriented polypropylene (BOPP), polyethylene terephthalate (PET), polyethylene-ethylene vinyl alcohol (PE-EVOH), cast polypropylene (CPP), Nylon (e.g., oriented polyamide (OPA)), polyethylene (PE), linear low density polyethylene (LLDPE), low density polyethylene (LDPE), medium density polyethylene (MDPE), high density polyethylene (HDPE), PET-PE, Metalized PET/PE, polypropylene (PP), biaxially oriented polypropylene (BOPP). In some examples, the second flexible material comprises a metallized paper in the form of a paper substrate coated on one surface with a layer of metal, for example, aluminium. In some examples, the second flexible material comprises a metallized plastic film in the form of a polymer substrate coated on one surface with a layer of metal, for example, aluminium. In some examples, the second flexible material comprises a metallized BOPP film, a metallized PET film, or a metallized polyethylene (PE) film. In some examples, the PET may comprise PET-silicon oxide, PET-aluminium oxide, polyethylene terephthalate-poly(vinyl alcohol) (PET-PVOH) or polyethylene terephthalate-polyvinylidene dichloride (PET-PVDC).

In some examples, the second flexible material of the flexible packaging material may be the innermost layer of the flexible packaging material in use. In some examples, the second flexible material may be referred to as a functional substrate. In some examples, the functional substrate may be functional in the sense that it provides a barrier function to protect the packaged goods. In some examples, the second flexible material may serve as a barrier to any external influence that could damage or otherwise reduce the quality of the packaged goods, in particular food, by preventing ingress of, for example, moisture, oxygen, other oxidants and pathogens such as viruses and bacteria.

In some examples, the second flexible material comprises a film or sheet, e.g., a thin film or sheet, of paper, metallic foil, and/or plastic. In some examples, the second flexible material comprises a metallic foil, a metallized substrate or a paper substrate. In some examples, the first flexible material comprises a metallized paper or a metallized plastic film. In some examples, the second flexible material comprises an aluminium foil. In some examples, the second flexible material is a polymeric second flexible material. In some examples the second flexible material comprises a film of a plastic material, for example, polyethylene (PE), linear low density polyethylene (LLDPE), low density polyethylene (LDPE), polypropylene (PP), biaxial oriented polypropylene (BOPP), or polyethylene terephthalate. In some examples, the second flexible material comprises a metallized paper in the form of a paper substrate coated on one surface with a layer of metal, for example aluminium. In some examples, the second flexible material comprises a metallized plastic film in the form of a polymer substrate coated on one surface with a layer of metal, for example aluminium. In some examples, the second flexible material comprises a metallized plastic film in the form of a metallized BOPP film, a metallized PET film, or a metallized polyethylene (PE) film.

In some examples, the second flexible material comprises a plurality of layers of film of material laminated together to form a pre-laminated flexible material. In some examples, the second flexible material comprises a plurality of layers of material selected from polymeric materials (e.g. polymeric materials selected from PE, LLDPE, MDPE, PP, BOPP, PET and OPA), metallic materials (e.g. metallic foils such as aluminium foil, or metallized films such as MET-PET (e.g. Al/PET), MET-BOPP (e.g. AI/BOPP), MET-BOPA (e.g. AI/BOPA) or any other metalized substrate), paper and combinations thereof. In some examples, the second flexible material comprises a plurality of layers of film of a plastic material, such as a combination of films selected from PE, LLDPE, MDPE, PP, BOPP, PET and OPA, laminated together to form the pre-laminated flexible material. In some examples, the pre-laminated flexible material comprises an aluminium layer. In some examples, the pre-laminated flexible material comprises a Paper/Alu/PE, PET/AI/PE, BOPP/MET-BOPP, AI/BOPA/PE or PET/PE laminate.

In some examples, the second flexible material comprises a film of a polymer, wherein the film is less than 100 μm in thickness, for example less than 50 μm in thickness, for example less than 45 μm in thickness, for example less than 40 μm in thickness, for example less than 35 μm in thickness, for example less than 30 μm in thickness, for example less than 25 μm in thickness, for example less than 20 μm in thickness, for example less than 15 μm in thickness, for example less than 10 μm in thickness, for example less than 5 μm in thickness. In some examples, the film of polymer is about 20 μm in thickness.

In some examples, the second flexible material comprises a film of a polymer, wherein the film is greater than 5 μm in thickness, for example greater than 10 μm in thickness, for example greater than 15 μm in thickness, for example greater than 20 μm in thickness, for example greater than 25 μm in thickness, for example greater than 30 82 m in thickness, for example greater than 35 μm in thickness, for example greater than 40 μm in thickness, for example greater than 45 μm in thickness, for example greater than 50 μm in thickness.

### Primer

In some examples, a primer is applied to the second flexible material before the second flexible material is contacted with the image layer.

In some examples, the primer comprises a primer resin. In some examples, the primer resin may be selected from the group comprising or consisting of hydroxyl containing resins, carboxylic group containing resins, and amine based polymer formulations. In some examples, a hydroxyl containing resin may be selected from polyvinyl alcohol resins, e.g. polyvinyl alcohol based such as polyvinyl butyral formulations (Butvar, Eastman), Vinnol® (Wacker polymers), cellulose derivative additives (Eastman), polyester (Dynapol, Evonic) and polyurethane based formulations with hydroxyl groups. In some examples, the carboxylic group containing resins may be selected from: olefin co-acrylic or methacrylic acid based copolymers, polyacrylic acid based polymers, and polylactic acid based polymers. In some examples, the amine based polymer formulations may be selected from polyamines and polyethylene imines. The primer resin may be selected from the group comprising, or consisting of, a polyvinyl alcohol resin, cellulose based resins, a polyester, a polyamine, a polyethylene imine resin, polyamide resin, polyurethane, copolymers of an alkylene monomer and an acrylic or methacrylic acid monomer, and polyacrylic polymers.

In some examples, the primer resin comprises a carboxylic functional group, an amine functional group or a polyol functional group. In some examples, the primer resin comprises an amine functional group or a carboxylic functional group.

In some examples, the primer resin comprises an amine functional group. In some examples, the primer resin comprises or consists of a polyethylene imine resin. Examples of a material suitable as a primer are DP050 and DP680 (available from Michelman, Inc.).

In some examples, the primer on the surface of the second flexible material of the flexible packaging material comprises a crosslinked primer resin.

In some examples, the primer is provided in an amount such that the coat weight of the primer resin on the second flexible material is at least 0.01 g/m², in some examples, at least 0.05 g/m², in some examples, at least 0.1 g/m², in some examples, at least 0.15 g/m², in some examples, at least 0.18 g/m², in some examples, at least 0.2 g/m², in some examples, at least 0.5 g/m², in some examples, at least 1 g/m², in some examples, at least about 1.5 g/m². In some examples, the primer is provided in an amount such that the coat weight of the primer resin on the second flexible material is up to about 0.01 g/m², in some examples, up to about 0.05 g/m², in some examples, up to about 0.1 g/m², in some examples, up to about 0.15 g/m², in some examples, up to about 0.18 g/m², in some examples, up to about 0.2 g/m², in some examples, up to about 0.5 g/m², in some examples, up to about 1 g/m², in some examples, up to about 1.5 g/m². In some examples, the primer is provided in an amount such that the coat weight of the primer resin on the second flexible material is 0.01 g/m² to 1.5 g/m² in some examples, 0.05 g/m² to 1 g/m², in some examples, 0.1 g/m² to 0.5 g/m², in some examples, 0.15 g/m² to 0.2 g/m², in some examples, 0.18 g/m² to 0.2 g/m².

In some examples, the second flexible material has a primer on the first surface and the image layer is contacted with the first surface of the second flexible material.

In some examples, the second flexible material has a first surface on which image layer is contacted, with a second surface of the second flexible material forming the outermost surface of the flexible packaging material. The second surface of the second flexible substrate being a surface other than the surface on which the ink composition is contacted, for example, the second surface of the second flexible material may be a surface opposing the first surface of the second flexible material.

In some examples, the second flexible material is contacted with the image layer on a first surface of the second flexible material. The image may be contacted with the first surface of the second flexible material in reverse with a second surface of the second flexible material forming the outermost surface of the flexible packaging material and the image appearing the right way round when viewed through the second surface of the second flexible material. Alternatively, the image may be transferred onto the thermally activatable laminating material of the layered substrate on the ITM in reverse with the first flexible material forming the outermost surface of the flexible packaging material and the image appearing the right way round when viewed through the layered substrate. Thus, the image is embedded within the multi-layer structure of the flexible packaging material and not on the outermost surface, and thus is protected from damage.

### EXAMPLES

The following illustrates examples of the methods and other aspects described herein. Thus, these Examples should not be considered as limitations of the present disclosure, but are merely in place to teach how to make examples of the present disclosure.

### Materials

Platinum PetPRO (available from Nobelus company): a layered substrate (thickness: 25 μm) comprising an ethylene vinyl acetate (EVA) adhesive (thickness: 13 μm; thermally activatable laminating material) disposed on a polyethylene terephthalate (PET) film (thickness: 12 μm; first flexible material).

Biaxially oriented polypropylene (BOPP; available from Jolybar company): a semi-matte transparent film with a thickness of 20 μm (second flexible material).

Electrolnk™ 4.5 (available from Hewlett-Packard Inc.): a liquid electrophotographic ink composition comprising chargeable particles comprising a resin (a 4:1 mixture of

Nucrel™ 699 (a copolymer of ethylene and methacrylic acid) and A-C 5120 (a copolymer of ethylene and acrylic acid)), a pigment, charge adjuvant (VCA) and a carrier liquid (Isopar L). A charge director (NCD) is added before printing.

DigiPrime™ 680 (available form Michelman): an aqueous primer formulation comprising a polyethylene imine resin.

Intermediate transfer member: an ITM comprising a metal cylinder on which is disposed a multi-layered structure, in which the surface layer is a random copolymer of ethylene, butyl acrylate, a haloalkyl ester of an alkenoic acid, and an alkenoic acid monomers.

### Example 1

The intermediate transfer member (ITM) was installed in an HP Indigo WS6600 printing press comprising an in-line priming unit and a substrate unwinder. The second flexible material (BOPP) was installed on the substrate unwinder of the printing press. The in-line priming unit applied a primer to the second flexible material (see Table 1) and the primed second flexible material was heated at 60° C. to dry the primer on the second flexible material.

TABLE 1
in-line primer application

| | |
|---|---|
| Primer | DP680 |
| Intermediate coating roller | 82 mm rough surface |
| Coating level | Medium |
| Drying temperature [° C.] | 60 |
| Corona intensity [W] | 800 |
| Heat sensitivity | High |

The layered substrate (Platinum PetPRO) was contacted with the ITM with the first flexible material (PET film) in contact with the ITM. Thus, the PET film contacts the ITM and the thermally activatable laminating material (EVA adhesive) formed the surface onto which LEP ink could be applied.

The liquid electrophotographic (LEP) printer was then used to print an image layer on the thermally activatable laminating material and contact (under conditions of heat and/or pressure) the image layer with the primer on the second flexible material thereby forming a flexible packaging material. Thus, a latent electrostatic image was formed on the photoimaging plate of the LEP printer and then a single colour LEP ink composition was transferred to the electrically charged portions of the latent image on the photoimaging plate. The LEP ink composition was then transferred from the photoimaging plate to the thermally activatable laminating material of the layered substrate, which was in contact with the intermediate transfer member of the LEP printer, forming an image layer on the thermally activatable laminating material. The ITM was at temperature of 95° C. and heated air was applied to the ITM at a temperature of 110° C. The heating of the ITM and the air temperature caused the carrier liquid in the LEP ink composition to evaporate and the chargeable particles in the LEP ink (comprising pigment and resin) to form a film on the surface of the EVA (thermally activatable laminating material), caused the EVA (thermally activatable laminating material) to soften (by heating to a temperature above the melting point of EVA). A feed fan (8 V) is used to remove evaporating liquid carrier from the area. Four further LEP ink compositions were then sequentially transferred to the EVA (thermally activatable laminating material) from the photoimaging plate to form a full colour image. Then, the movement of the ITM transferred the layered substrate into contact with the primer on the second flexible material. Pressure (20 kg) is applied and the ITM temperature continues to apply heat (95° C.) that activates the thermally activatable laminating material, which adheres the first flexible material to the second flexible material with the thermally activatable laminating material, image layer and primer disposed between the first and second flexible materials. The five coloured LEP ink compositions used were cyan, magenta, yellow, black (key) and white.

### Results

Tests have shown that the complete LEP ink image was transferred from the photoimaging plate to the thermally activatable laminating material of the layered substrate on the ITM. Furthermore, the ink/EVA/PET was also completely transferred from the ITM to the BOPP film (second flexible material) forming the flexible packaging material.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims. Unless otherwise stated, the features of any dependent claim can be combined with the features of any of the other dependent claims and any of the independent claims.

1. A process for preparing a flexible packaging material comprising:
contacting a first flexible material of a layered substrate with an intermediate transfer member; wherein the layered substrate comprises the first flexible material and a thermally activatable laminating material disposed on the first flexible material;
transferring an electrophotographic ink composition from a photoimaging plate onto the thermally activatable laminating material of the layered substrate on the intermediate transfer member to form an image layer on the thermally activatable laminating material; and
contacting, under conditions of heat and/or pressure, the image layer with a second flexible material thereby forming the flexible packaging material.

2. The process according to claim 1, wherein the surface layer of the intermediate transfer member comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.

3. The process according to claim 1, wherein image layer is contacted with the second flexible material at a temperature in the range of 60° C. to 140° C.

4. The process according to claim 1, wherein the conditions of heat and/or pressure comprise heating to a temperature below the melting point of the first flexible material.

5. The process according to claim 1, wherein the electrophotographic ink composition is a liquid electrophotographic ink composition.

6. The process according to claim 5, wherein carrier liquid of the liquid electrophotographic ink composition is at least partially evaporated after the liquid electrophotographic ink composition is transferred from the photoimaging plate onto the thermally activatable laminating material and before the image layer is contacted with the second flexible material.

7. The process according to claim 1, wherein the first flexible material comprises a thermoplastic polymer.

8. The process according to claim 1, wherein the thermally activatable laminating material comprises a copolymer of an alkylene monomer and a monomer selected from alkenyl esters, acrylates and methacrylates.

9. The process according to claim 1, wherein the second flexible material comprises one or more of paper, metallic foil, and a polymeric substrate.

10. The process according to claim 1, wherein a primer is applied to the second flexible material before the second flexible material is contacted with the image layer.

11. An electrophotographic printer comprising:
a photoimaging plate; and
an intermediate transfer member;
wherein the surface layer of the intermediate transfer member comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.

12. The electrophotographic printer according to claim 11, wherein the surface layer of the intermediate transfer member comprises an acrylic rubber.

13. The electrophotographic printer according to claim 11, wherein the surface layer of the intermediate transfer member comprises a random copolymer formed by polymerisation of a monomer selected from alkyl esters of acrylic acid and alkyl esters of methacrylic acid and a monomer selected from an alkyl halide monomer and a carboxylic acid containing monomer.

14. An electrophotographic printer comprising:
a photoimaging plate; and
an intermediate transfer member;
wherein, in use, a first flexible material of a layered substrate is contacted with the intermediate transfer member; wherein the layered substrate comprises a first flexible material and a thermally activatable laminating material disposed on the first flexible material;
an electrophotographic ink composition is transferred from the photoimaging plate onto the thermally activatable laminating material of the layered substrate on the intermediate transfer member to form an image layer on the thermally activatable laminating material; and
the image layer is contacted with a second flexible material under conditions of heat and/or pressure thereby forming the flexible packaging material.

15. The electrophotographic printer according to claim 14, wherein the surface layer of the intermediate transfer member comprises a material selected from an acrylic rubber, a nitrile rubber, a hydrogenated nitrile rubber, a polyurethane elastomer, an ethylene propylene diene polymer, a fluorocarbon rubber, a perfluorocarbon rubber, a thermoplastic polyurethane and combinations thereof.
